(19) United States
(12) Patent Application Publication
(10) Pub. No.: US 2026/0249770 A1
(43) Pub. Date: Aug. 27, 2026

(54) TILTING TRAILER

(71) Applicant: Jeff Mynsberge, Mishawaka, IN (US)

(72) Inventor: Jeff Mynsberge, Mishawaka, IN (US)

(21) Appl. No.: 19/547,153

(22) Filed: Feb. 23, 2026

Related U.S. Application Data
(60) Provisional application No. 63/764,248, filed on Feb. 27, 2025.

(51) Int. Cl. B60P 3/34; B60S 9/04; B62D 25/20; B62D 63/06; B62D 63/08

(52) U.S. Cl. CPC B60P 3/34; B60S 9/04; B62D 25/20; B62D 63/061; B62D 63/08

(57) ABSTRACT

A trailer with a pivotal frame is pivotable between a stored position and a use position. The stored position locates the pivotal fame overlying and adjacent to the lower frame and the use position pivots the pivotal frame away from the lower frame. The pivotal frame is at an oblique angle with respect to the lower frame in the use position. An actuator is for moving the pivotal frame with respect to the lower frame. A living area connected to the pivotal frame has a first floor and a second floor at an oblique angle with respect to the pivotal frame. The first and second floors are at an oblique angle with respect to the lower frame when the pivotal frame is in the stored position. The first and second floors are substantially parallel to the lower frame when the pivotal frame is in its use position.

### CROSS REFERENCE TO RELATED APPLICATIONS

This application is a Utility of the U.S. Application Serial No. 63/764,248, filed February 27, 2025, and claims the priority thereof and is hereby incorporated in its entirety by reference.

### BACKGROUND

Maximizing space in a recreational vehicle (RV) has been an important innovation to make them be more comfortable and useful. The more interior living space an RV has, the more comfortable and useful it will be. However, increasing the living space within an RV can have the drawback of making the entire RV larger. In the past, maximizing the living space within an RV while attempting to keep it relatively small has been done with slide out rooms. Slide out rooms have their drawbacks. They are often hard to seal and require complex mechanisms to actuate them. Additionally, slide out rooms increase the overall width of the RV from which they extend. That means that the parking area or footprint an RV covers will be significantly increased. There remains an unmet need for an RV having a relatively small footprint that includes the ability to maximize the living space within it. Using spaces for more than one purpose increases the utility of small spaces within an RV.

### SUMMARY OF THE INVENTION

A trailer having a lower frame and a pivotal frame that is pivotally connected to the lower frame with a hinge. The pivotal frame is pivotable between a stored position and a use position. The stored position locates the pivotal fame overlying and adjacent to the lower frame. The use position is characterized by the pivotal frame being spaced at a relatively farther distance from the lower frame when compared to the stored position. The pivotal frame is at an oblique angle with respect to the lower frame in the use position. An actuator is for moving the pivotal frame with respect to the lower frame. A living area is supported by the pivotal frame, and the living area has a first floor at an oblique angle with respect to the pivotal frame. The living area also has a second floor that is spaced from the first floor and is substantially parallel to the first floor. The first and second floors are at an oblique angle with respect to the pivotal frame. The first and second floors are at an oblique angle with respect to the lower frame when the pivotal frame is in the stored position. The first and second floors are substantially parallel to the lower frame when the pivotal frame is in its use position.

### BRIEF DESCRIPTION OF THE DRAWINGS

FIG. 1 is a side view of the trailer showing the pivotal frame in its stored position;

FIG. 2 is a side view of the trailer of FIG. 1 showing the pivotal frame moving toward its use position;

FIG. 3 is a side view of the trailer in FIGS. 1 and 2 showing the pivotal frame in its use position;

FIG. 4 is a cut away view of the trailer shown in FIGS. 1-3 that provides a view of the main living area;

FIG. 5 is a side view of the trailer shown in FIGS. 1-5 showing the pivotal frame in its use position that shows external walls and external features;

FIG. 6 is an illustration explaining the general principle of how space is used in a less efficient way under the prior art designs for recreational vehicles;

FIG. 7 is an illustration explaining the general principle of how space is used in a more efficient way with the present invention;

FIG. 8 is an illustration comparable to FIG. 6 showing how the floor space is used in prior art recreational vehicles;

FIG. 9 is an illustration comparable to FIG. 7, and shows how effectively space is utilized with the present invention;

FIG. 10 is a top view showing the hitch of the trailer and the front cap area containing a shower and toilet; and

FIG. 11 is an interior view of the trailer shown in FIGS. 1-10 as seen through the back wall of the trailer.

### DETAILED DESCRIPTION OF THE INVENTION

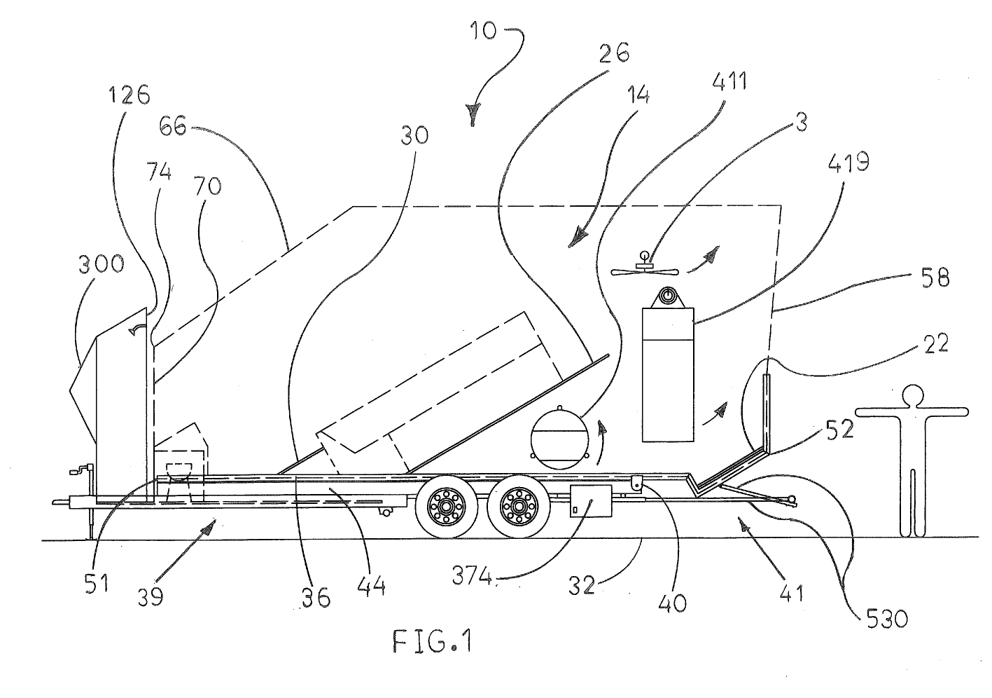

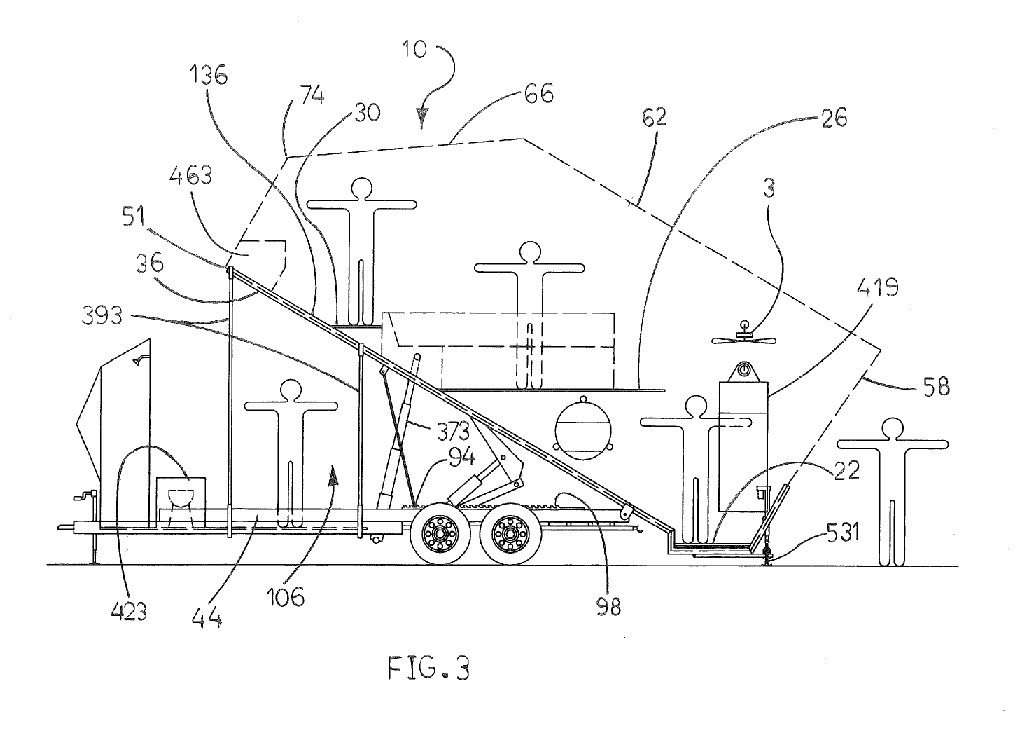

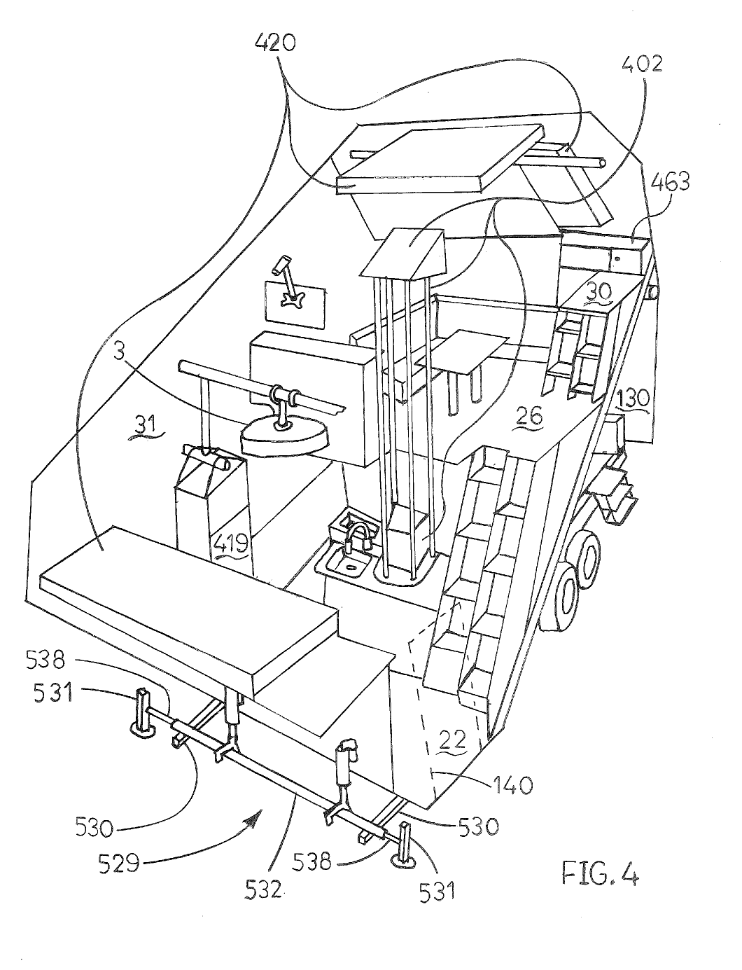

The present invention is for a tilting trailer 10 that has a main living area 14 that has multiple floors therein. FIG. 1 shows a side view of the main living area 14. The main living area 14 has a first floor 22, a second floor 26, and a third floor 30 and lateral walls 31. As shown in FIG. 4 the trailer 10 rests on a ground surface 32. The main living area 14 is supported by a pivotal frame 36. The pivotal frame 36 has a hinge 40 that is connected pivotally to a lower frame 44. The hinge 40 is located at a rear end of the lower frame 44. The pivotal frame 36 is movable from a stored position (shown in FIG. 1) and a use position (shown in FIG. 3). The stored position locates the pivotal frame 36 overlying and resting upon a lower frame 44 and corresponds to the pivotal frame 36 being substantially parallel to the lower frame 44. The use position locates the pivotal frame 36 spaced from the lower frame 44 and at an oblique angle with respect to the lower frame 44. A first side 39 of the hinge 40 is the front portion of the trailer 10 nearer the hitch and front of the trailer 10. In FIGS. 1, 2, and 3, the first side 39 of the hinge 40 is that portion of the trailer 10 located to the left of the pivot point of hinge 40. An oppositely located second side 41 of the trailer 10 is on the opposite side of the hinge 40. In FIGS. 1, 2, and 3, the second side 41 of the hinge 40 is that portion of the trailer 10 located to the right of the pivot point of hinge 40. The lower frame 44 has axles 48 with wheels 50 thereon. The pivotal frame 36 has a front edge 51 and a rear edge 52. In the stored position, the front edge 51 is located at a first distance with respect to the lower frame 44 and that first distance is zero due to the pivotal frame 36 being in direct contact and resting on the lower frame 44. In the use position, the front edge 51 is located at a second distance with respect to the lower frame 44 and that second distance is larger than the first distance. The rear edge 52 of the pivotal frame 36 is directly adjacent to the first floor 22. The first floor 22 is at an approximately thirty-degree angle with respect to the pivotal frame 36. The second floor 26 and third floor 30 are parallel to the first floor 22 and thus, both are also at a thirty-degree angle with respect to the pivotal frame 36. The first floor 22 is joined to a back wall 58 that is substantially perpendicular to the lower frame 44 when the pivotal frame 36 is in its stored position. The back wall 58 continues into and is connected to a main ceiling 62 that is substantially parallel to the pivotal frame 36. The main ceiling 62 is connected to a stub ceiling 66 that is angled with respect to the main ceiling 62. The stub ceiling 66 is parallel to the floors 22, 26, 30. The stub ceiling 66 meets a front wall 70 at leading edge 74.

The pivotal frame 36 is moved with respect to the lower frame 44 with a hydraulic actuator 78. The hydraulic actuator 78 may be a screw machine or other type of actuator. As the hydraulic actuator 78 moves the pivotal frame 36 from its stored position to its use position, a catch mechanism 84 is used to follow the movement of the pivotal frame 36 upward with a mechanical stop that would prevent the pivotal frame 36 from falling. The catch mechanism 84 serves as a locking mechanism that allows for pivotal movement of the pivotal frame 36 away from the lower frame 44 and restraining movement of the pivotal frame 36 back toward the lower frame 44. The catch mechanism 84 has a follower linkage 90 having a proximal end 92 pivotally connected to the pivotal frame 36 and an oppositely located distal end 94. The distal end 94 moves along a rack 96 located on the lower frame 44 and the distal end 94 catches teeth 98 in the rack 96 to prevent the pivotal frame 36 from falling toward the lower frame 44 if the hydraulic actuator 78 were to fail. The follower linkage 90 may be selectively disengaged from the teeth 98 in the rack 96 to allow the pivotal frame 36 to be lowered when it is desired to do so.

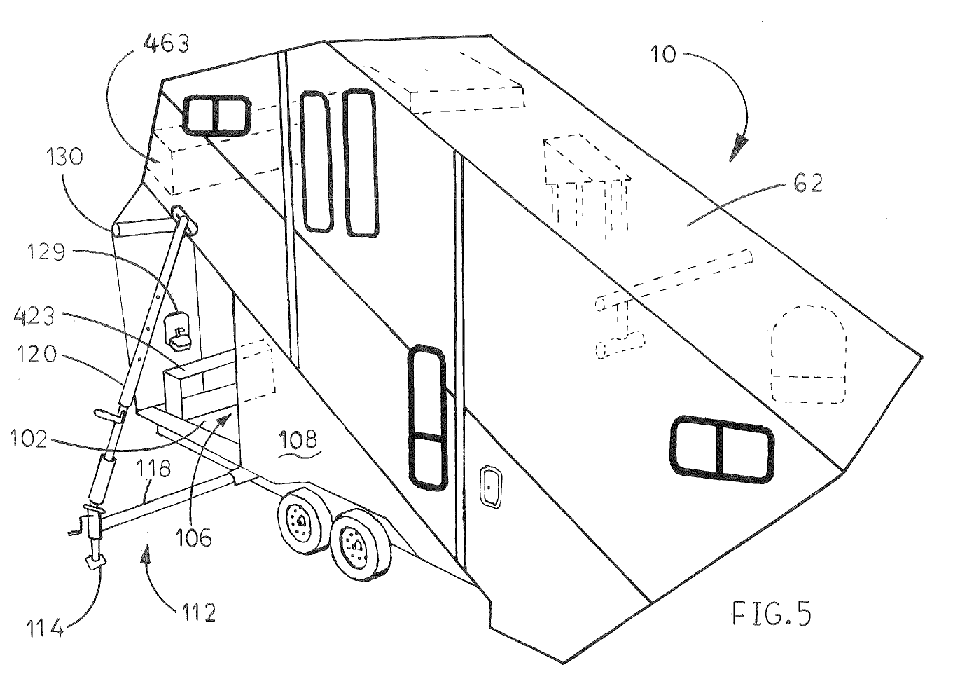

As the pivotal frame 36 moves into its use position, the entire main living area 14 is tilted upward so that pivotal frame 36 is at an approximate thirty-degree angle with respect to the lower frame 44. As shown in FIG. 3, the use position of the pivotal frame 36 is located above the lower frame 44 and above a sub floor 102 which is attached to the front portion of the lower frame 44 by hinge 40. The use position locates the front edge 51 at a second distance that is farther from the lower frame 44 because the front edge 51 is spaced well above the lower frame 44. As mentioned above, the sub floor 102 is on a first side 39 of the hinge 40. In this use position, the pivotal frame 36 is pivoted approximately thirty-degrees with respect to the lower frame 44. The sub floor 102 forms the floor of a front room 106 that has lateral walls 108, one of which is shown in FIG. 5. The use position of the pivotal frame 36 is also supported by outriggers 112 that have an adjustable foot 114, a bottom member 118, and a top member 120. The top member 120 is selectively lockable and telescoping in length and can hold the position of the pivotal frame 36. This is done with pins extending through holes in telescoping tubes within the top member 120 that fix the top members 120 at predetermined lengths with respect to the bottom members 118. The top members 120 support the pivotal frame 36 because each top member 120 is connected to one of the lateral walls 31 of the main living area 14. The outriggers 112 act as an additional safety feature to the catch mechanism 84 that prevent the pivotal frame 36 from falling. The outriggers 112 may also include a screw adjustment within the top member 120 to provide fine adjustment of their length. The outriggers 112 are movable from a retracted position and to an extended position. The outriggers 112 are selectively lockable and this locking mechanism that makes the outriggers 112 selectively lockable and the manner in which they are lockable is not limited to the use of pins extending through holes. The selectively lockable nature of the outriggers 112 refers to the outriggers 112 being lockable when they are extended, as shown in FIG. 5, so that the outriggers 112 may support the pivotal frame 36 and everything attached to the pivotal frame 36 when the pivotal frame 36 is in its use position. The selective locking of the outriggers 112 may be accomplished by numerous mechanisms that allow the outriggers 112 to be locked at their extended length that corresponds to the pivotal frame 36 being in its use position. The outriggers 112 are movable from a retracted position corresponding to when they are not in use to an extended position (as shown in FIG. 3) when they are in use.

The front room 106 includes a bulkhead wall 126 that is located ahead of the front wall 70 of the main living area 14. The bulkhead wall 126 helps support a front cap 300. The bulkhead wall 126 forms a wall of the front room 106 and houses mechanical components that are not well suited to movement. Such mechanical components may include plumbing fixtures such as a sink 129. This can be the location of a marine sink 129 that flips up to become flush with the inside of the bulkhead wall 126. This folding allows the pivotal frame 36 to pivot without striking the sink 129. The bulkhead wall 126 may include a spring loaded and retractable awning 130 that can serve as a roof for a portion of the front room 106. The front room 106 may be configured in many ways to augment the space below the pivotal frame 36 when the pivotal frame 36 is in its use position. The front room 106 provides a significant expansion of the useable living area 14.

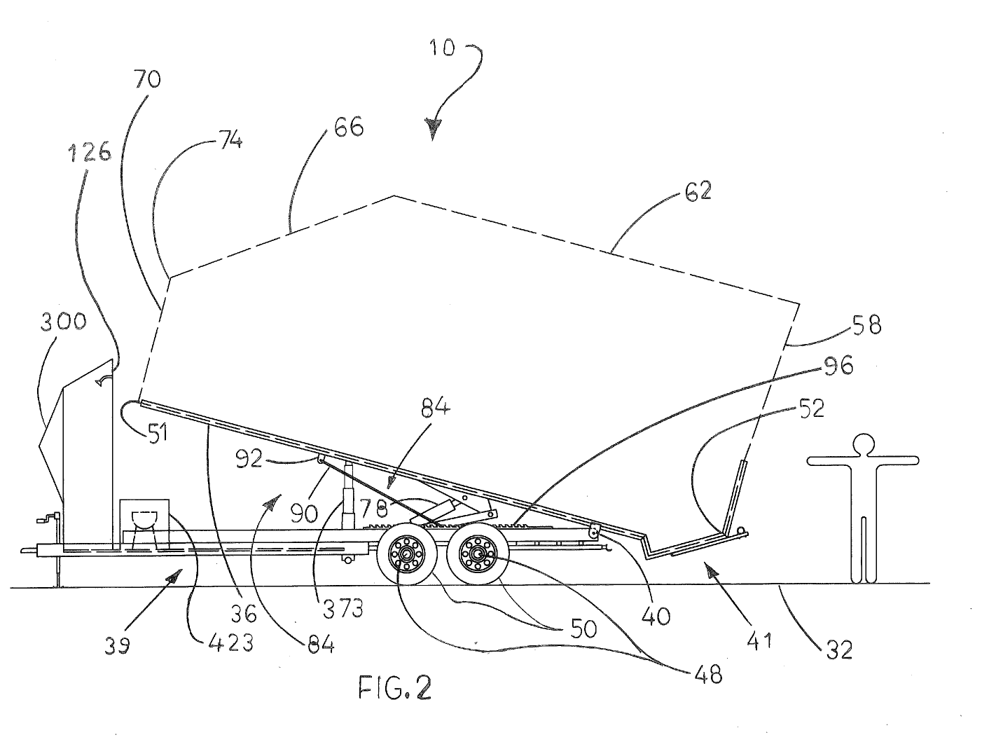

When the pivotal frame 36 is in its stored position, each of the first, second, and third floors 22, 26, 30 slope downwardly traversing in a direction away from the main ceiling 62 toward a pivotal frame wall 136. The floors 22, 26, 30 slope downwardly at a thirty-degree angle. Thus, the floors 22, 26, and 30 are at a thirty-degree angle with respect to the lower frame 44. As the pivotal frame 36 is moved from its stored position into its use position, the pivotal frame 36 is rotated clockwise thirty-degrees to arrive in its use position, as shown in FIGS. 2. Thus, the pivotal frame 36 is at a thirty-degree angle with respect to the lower frame 44. This locates the floors 22, 26, 30 to be parallel to the ground 32 and parallel to the lower frame 44 when the pivotal frame 36 is in its use position. In this use position, the pivotal frame wall 136, the main ceiling 62, and the lateral walls 31 define the areas of the individual rooms above each of the floors 30, 26, 22.

The first floor 22 is located on the opposite side of hinge 40, as opposed to the second and third floors 26, 30. The first floor 22 is also located rearward of the hinge 40 and at a location extending beyond the lower frame 44. This corresponds to the first floor 22 being located on the second side 41 of the hinge 40. Due to the first floor 22 being in a cantilevered location with respect to the lower frame 44, the first floor 22 is moved nearer the ground 32 when the pivotal frame 36 is moved into its use position. This locates a door 140 nearer the ground 32 than the lower frame 44 and provides more convenient access to the main living area 14. This is because the first floor 22 moves closer to the ground surface 32 as the pivotal frame 36 moves from its stored position to its use position. The first floor 22 is cantilevered because the hinge 40 is located at the rear end of the lower frame 44. As such, no part of the lower frame 44 is located beyond the hinge 40. This leaves the area below the first floor 22 open because no portion of the lower frame 44 is located beneath the portion of the pivotal frame 36 that is on the second side 41 of the hinge 40 described above.

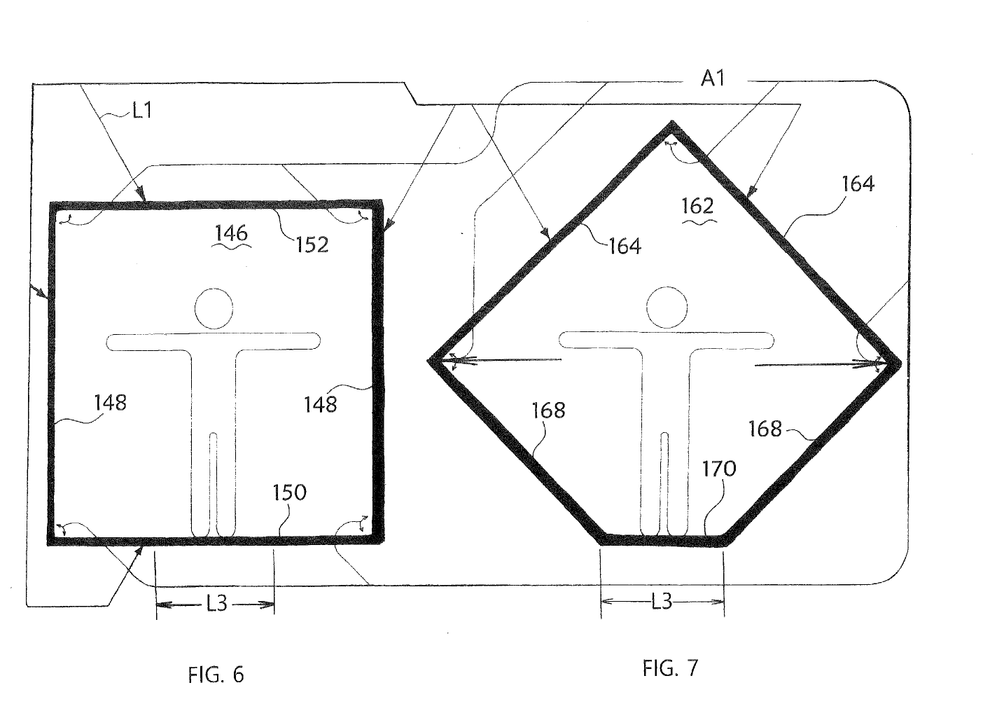

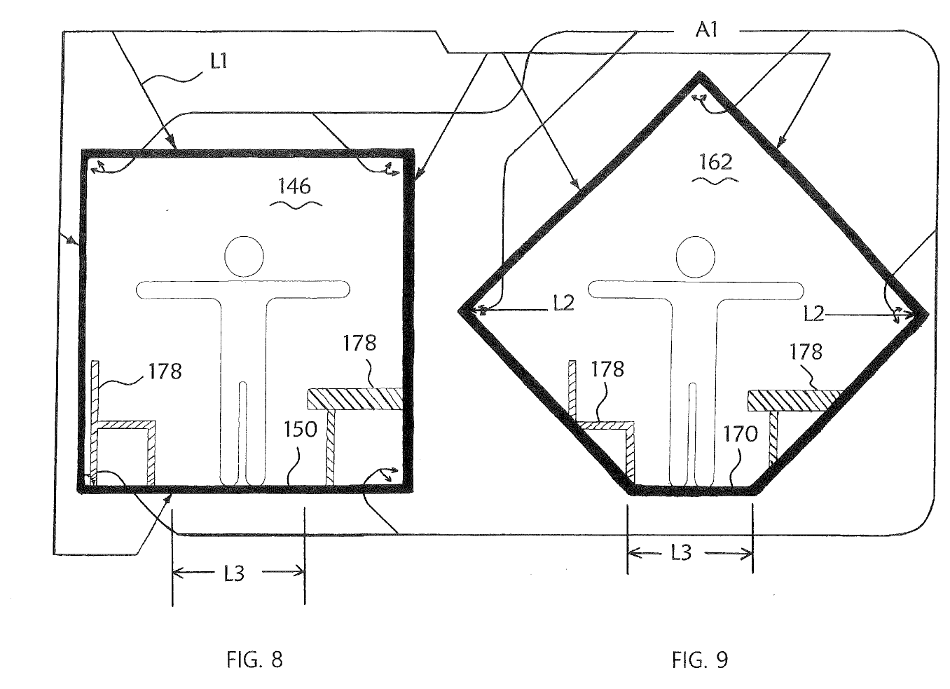

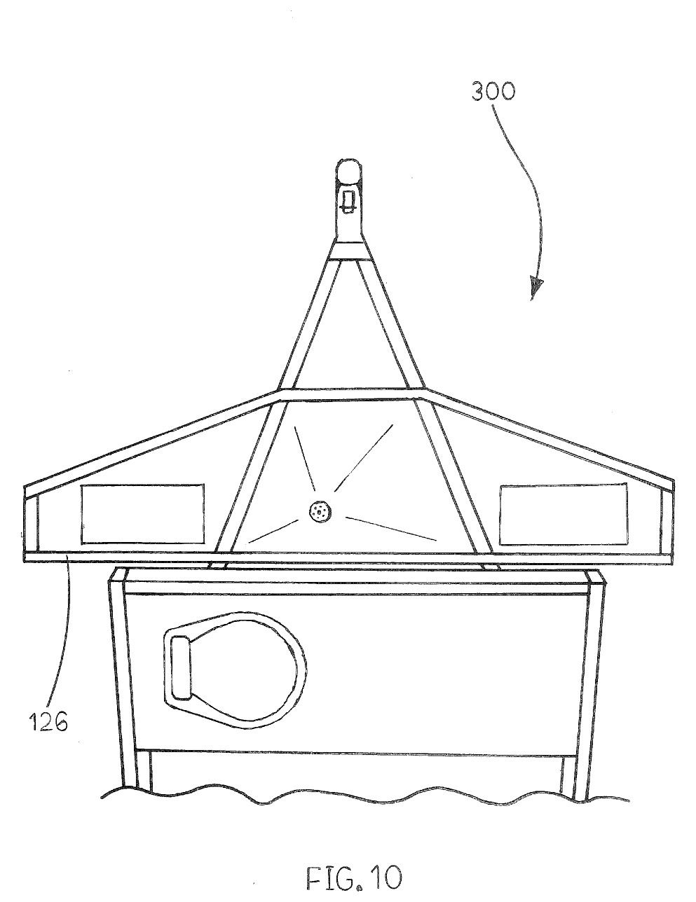

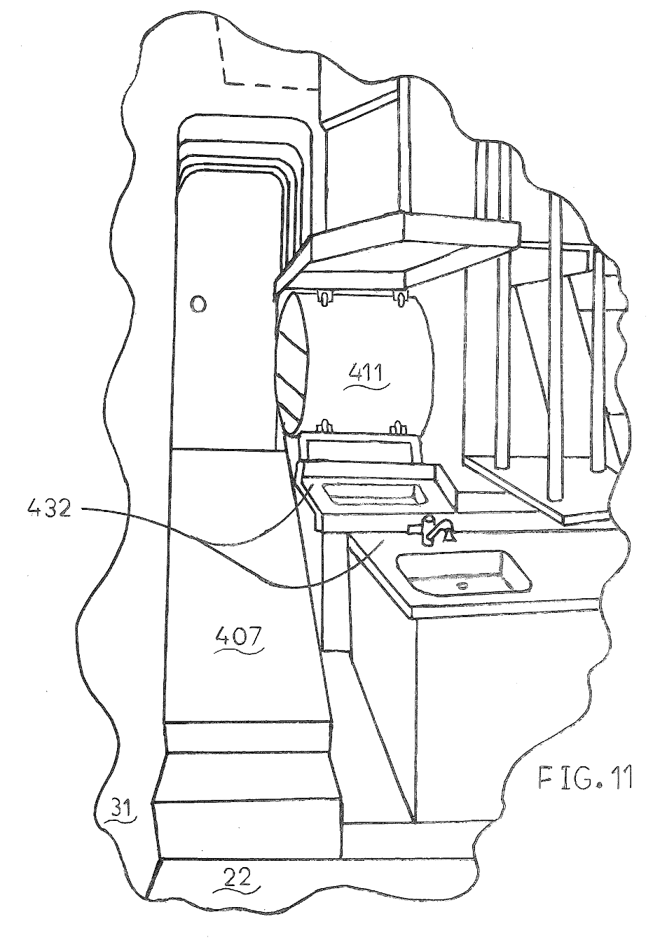

FIGS. 6-9 provide an explanation of the benefits of the present invention. A room 146 constructed according to the layout shown in FIG. 6 has a length L1 that defines the width of the room 146. This width being L1 defines the space between sidewalls 148 that meet a floor 150 at ninety-degree angles to the floor 150. Thus, the width of the room 146 from the floor 150 to the ceiling 152 is constant for the entire vertical height of the room 146. Often times, the areas adjacent to the floor 150 are at a relatively low vertical height above the floor 150 and are consumed with furniture or appliances. A room 162 constructed according to the layout shown in FIG. 7 has L1 corresponding to a length of an angled ceiling portion 164 that meets another angled ceiling portion 164. The angled ceiling portion meet at ninety-degrees. In the configuration shown in FIG. 7, areas of the room 162 above to the floor 170 have an increased width that opens up to width L2 that is wider than the width L3 of the floor 170. L2 defines a significantly wider area in the middle height of the room 162 than the room 146 shown in FIG. 6. The area from the middle height of the room 162 to the floor 170 may be consumed by furniture or appliances that are built to accommodate the angled sidewalls 168. However, the furniture or appliances consuming some of the width of the room 162 will not affect the useable area of the room 162 to the extent that a room like that of room 146 in FIG. 6. The overall perception of room 162 will be that it feels larger because of the wider distance L2 at the middle height of the room 162, and the overall useable space will be more effectively configured to allow the same freedom of movement with less cubic space used. FIG. 8 shows furniture 178 that consumes space on the floor 150. In room 146 in FIG. 8, the walkable space on the floor 150 is approximately L3, which is the same width L3 on the floor 170 shown in FIG. 9. Taller ceiling in room 162 shown in FIGS. 7 and 9 allow for greater head room and enhance the spacious feel of room 162. FIGS. 6-9 show the same corner angles A1 may be used where walls 148, 168 and ceilings 152, 164 meet.

The concepts related to FIGS. 6-9 apply directly to the main living area 14 of the trailer 10. The floors 22, 26, 30 within the main living area 14 being obliquely angled with respect to the pivotal frame wall 136 and the main ceiling 62 are able to cover a wider lateral distance when the pivotal frame 36 is in its use position. Thus, it is possible to increase the main living area 14 useable space without the use of complex slide out rooms. Further, the pivoting of the pivotal frame 36 with respect to the lower frame 44 will provide an additional front room 106 that is located below the main living area 14. The configuration of the present invention provides an expandable living area yet maintains a relatively small footprint that allows the trailer 10 to be parked in a relatively small area because no further area will be consumed in any direction extending from any lateral surface of the trailer 10.

As the pivotal frame 36 is pivoted from its stored position to its use position, this can create challenges for furnishings within the living area 14. There are some items that must remain level to the ground surface 32 no matter what pivotal frame 36 is in. For instance, the refrigerator 419 is a gimbaled device that will pivot to remain level with the ground surface 32 when the pivotal frame 36 moves from its stored position to its use position. This is shown in FIG. 1 and also shown in FIG. 4. Other items that are gimbaled are shelving 411, and ceiling fan 3.

The trailer 10 includes a bumper 529 that has a cross-member 532 that telescopically holds outer tubes 538. The outer tubes 538 are connected to feet 531 that are for contacting the ground surface 32. Offset tubes 530 are pivotally connected to the bottom of the first floor 22 as shown in FIG. 1. This allows the bumper 529 to serve multiple uses. In addition to its use as bumper 529 when the trailer 10 is being towed, the bumper 529 may also serves as a stabilizing outrigger system that works in conjunction with the outriggers 112. The combination of the outriggers 112 near the front of the trailer 10 and the bumper 529 at the rear of the trailer 10 provide an extremely wide footprint that will prevent the trailer 10 from tipping over when the pivotal frame 36 is in its use position.

The configuration of the trailer 10 can be used to accommodate any portable structure that would benefit from an elevated vantage point above the ground surface 32. The third floor 30 provides an elevated vantage point that is extremely useful for certain uses. The trailer 10 of the present invention may be useful for applications as military mobile headquarters, mobile police tactical centers, marketing trailers, or concession trailers. In a concession type use it is possible to have concessions on lower portions of the trailer 10 and a press box in the upper portion of the trailer 10. The trailer 10 may also be useful for portable mobile air traffic controller centers.

Components of the trailer shown in the FIGS include the following:

A lockable control box 347 for power to the actuator 78 and also controls for a hand pump connected to a telescoping cylinder 373. Cylinder 373 may serve as another lockable safety feature in the event that actuator 78 were to fail. A hand pump may be used to move the telescoping cylinder 373 from a retracted to an extended position (shown in FIG. 2). Cylinder 373 may be used to lift the pivotal frame 38 or may also be used to slow the descent of the pivotal frame 36 from the use position to the stored position.

Carbon fiber tubes 393 fit into receivers that are attached to the pivotal frame 36 and the lower frame 44. The carbon fiber tubes 393 maintain the pivotal frame 36 in its use position as shown in FIG. 3.

Hinged walls 423 that fold up and stow away are tied into the fixed bulkhead wall 126 and can surround the sink and toilet area.

There are three sleeping mattresses 420 shown in FIG. 4 that may be stowed as shown in FIG. 4. One of the sleeping mattresses 420 is stowed in a slot against the ceiling 62.

A free-standing dumb waiter 402 goes from the first floor 22 to the second floor 26.

A storage cabinet 463 extends the full width of the third floor. There is no bottom in the area of the cabinet 463 that is directly above the toilet. This is to allow the toilet to be within the cabinet 463 when the pivotal frame 36 is in the stored position. This cabinet 463 is shown in FIGS. 3, 4, and 5.

A two-level countertop 432 has two sink basins. This is shown in FIG. 11. This component is only connected to the lower frame. Thus, it does not pivot and is maintained level to the ground surface 32.

A hallway 407 that has a ceiling that doubles as a bench seat of a dinette on the second floor 26. A door at the end of the hallway 407 leads to the front room 106.

The invention is not limited to the details above, but may be modified within the scope of the following claims.

What is claimed is:

1. A trailer comprising:
a lower frame and, a pivotal frame pivotally affixed to said lower frame, said pivotable frame pivotable about a hinge with respect to said lower frame, said pivotable;
frame pivotable between a stored position and a use position, said stored position locating said pivotal frame overlying and adjacent to said lower frame, said use position characterized by said pivotal frame being spaced at a relatively farther distance from said lower frame and said pivotal frame being at an oblique angle with respect to said lower frame in said use position;
an actuator for moving said pivotal frame with respect to said lower frame;
an axle affixed to said lower frame;
a living area supported by said pivotal frame, said living area having a first floor at an oblique angle with respect to said pivotal frame, said living area having a second floor spaced from said first floor and being substantially parallel to said first floor, said first and second floors being at an oblique angle with respect to said pivotal frame, and said first and second floors being at an oblique angle with respect to said lower frame when said pivotal frame is in said stored position and said first and second floors being substantially parallel to said lower frame when said pivotal frame is in said use position; and
a sub floor affixed to said lower frame, said sub floor being located on a first side of said hinge and said first floor being located on an opposite side of said hinge, said stored position of said pivotal frame locating said pivotal frame adjacent and overlying said sub floor and said use position of said pivotal frame locating said pivotal frame at a relatively far distance from said sub floor and said pivotal frame becoming a ceiling to a room located above said sub floor.

2. The trailer of claim 1, wherein said living area includes a main ceiling being substantially parallel to said pivotal frame and a stub ceiling being at an oblique angle with respect to said pivotal frame, said main ceiling being substantially parallel to said lower frame when said pivotal frame in said stored position and at an oblique angle with respect to said lower frame when said pivotal frame is in said use position.

3. The trailer of claim 2, wherein trailer is supported by a ground surface and when said pivotal frame moves from said stored position to said use position, said first floor moves closer to said ground surface.

4. The trailer of claim 3, wherein said first floor moves below said lower frame when said pivotal frame moves into said use position.

5. A trailer comprising:
a lower frame and a pivotal frame, said pivotal frame pivotal with respect to said lower frame about a hinge connecting said pivotal frame to said lower frame, said pivotal frame pivotable between a stored position and a use position, said stored position locating said pivotal frame overlying and adjacent to said lower frame, said use position characterized by said pivotal frame being spaced at a relatively farther distance than said storage position from said lower frame and said pivotal frame in said use position being at an oblique angle with respect to said lower frame in said use position;
an actuator for moving said pivotal frame with respect to said lower frame, said actuator having a retracted position corresponding to said pivotal frame being in said stored position and said actuator having an extended position corresponding to said use position; and
a living area supported by said pivotal frame, said living area having a first floor at an oblique angle with respect to said pivotal frame, said living area having a second floor spaced from said first floor, said second floor being substantially parallel to said first floor, said first and second floors being at an oblique angle with respect to said lower frame, and said first and second floors being at oblique angles with respect to said lower frame when said pivotal frame is in said stored position and said first and second floors being substantially parallel to said lower frame when said pivotal frame is in said use position.

6. The trailer of claim 5, wherein said second floor is on a first side of said hinge and said first floor is on a second side of said hinge said second floor being cantilevered with respect to said lower frame so that movement of said pivotal frame from said stored position to said use position locates said first floor nearer to a ground surface upon which said trailer rests in said use position that the location of said first floor when said pivotal frame is in said stored position.

7. The trailer of claim 5, wherein said pivotal frame is connected to a pair of outriggers each of said outriggers being movable between an extended position and a retracted position, said outriggers being selectively lockable.

8. The trailer of claim 5, wherein said pivotal frame is connected to a locking mechanism allowing for pivotal upward movement of said pivotal frame with respect to said lower frame and restraining said pivotal frame from pivoting toward said lower frame.

9. The trailer of claim 6, wherein a sub floor is affixed to said lower frame, said sub floor being located on said first side of said hinge, said stored position of said pivotal frame locating said pivotal frame overlying said sub floor and said use position of said pivotal frame locating said pivotal frame at a relatively far distance from said sub floor and said pivotal frame becoming a ceiling to a room located above said sub floor.
